(19) United States
(12) Patent Application Publication
(10) Pub. No.: US 2026/0234886 A1
(43) Pub. Date: Aug. 13, 2026

(54) A SYSTEM AND A METHOD FOR COLLECTION OF MICRO-PLASTICS

(71) Applicant: Nobuyoshi MORIMOTO, Tokyo (JP)

(72) Inventor: Nobuyoshi MORIMOTO, Tokyo (JP)

(21) Appl. No.: 19/471,025

(22) PCT Filed: Mar. 29, 2024
(86) PCT No.: PCT/IB2024/053082

§ 371 Date: Sep. 30, 2025

(30) Foreign Application Priority Data
Mar. 30, 2023 (IN) 202311023767

(51) Int. Cl. E02B 15/10; B63B 35/32; C02F 1/00; C02F 1/24; C02F 1/28; C02F 101/32; C02F 103/00; C02F 103/08; E02B 1/00

(52) U.S. Cl. CPC E02B 15/108; B63B 35/32; C02F 1/008; C02F 1/24; C02F 1/285; E02B 1/003; C02F 2101/32; C02F 2103/007; C02F 2103/08; C02F 2209/40

(57) ABSTRACT

The present invention provides a system and method for enhancing adhesion between micro-plastics and air bubbles. More specifically, the present invention relates to a system and a method to enhance adhesion between micro-plastics and air bubbles so that the maximum number of micro-plastics can be collected from the aquatic environment. The pressure differential at the stern portion, buttock stern to bottom baseline, and between the air bubble's outflow and inlet maximises collection efficiency. The collected phytoplankton is re-introduced onto the ocean surface to improve CO₂ to O₂ conversion as a global warming mitigation method.

### FIELD OF THE INVENTION

The present invention generally relates to collection of micro-plastics from aquatic environment. More specifically, the present invention relates to a system and a method for collection of micro-plastics in aquatic environment using adhesion properties of synthetic polymers or starch.

### BACKGROUND OF THE INVENTION

Statistics show that humans have produced plastics that weigh nearly the same as the entire human population. Approximately, 91% of all produced plastic is not recycled and ends up into landfills, drainage systems, rivers and oceans. Plastic ends up clogging drainages systems and polluting water bodies. At this rate, it is estimated that there will be more plastic than fish in the ocean (by weight) after a certain period of time.

Over a period of time, due to exposure to sunlight and as a result of environmental factors such as weather conditions, larger plastics breakdown into smaller micro-plastics. The micro-plastics also result from commercial product development such as cosmetics, textiles or the like. These micro-plastics take decades or more to degrade completely.

Every living organism on the Earth has some level of exposure to micro-plastics. The micro-plastics have been detected even in the zooplankton which are the smallest marine creatures. These micro-plastics are swallowed by fishes and other sea creatures directly or indirectly, ending up in our food chain. The impact of micro-plastics on human health is beyond imagination. Micro-plastics are generally defined as plastic items smaller than 5 mm.

There are many organizations like UN and other independent organizations which are working on the issue of plastic in the ocean. However, most of such organizations are focusing on a dedicated system that can collect plastics from ocean, sea or river.

In view of the above limitations of the current technologies, there exists a need to develop an effective system and method for collection of micro-plastics utilizing the adhesion properties of synthetic polymers with air bubbles containing micro-plastics in a route of a vessel (1).

Thus, the above-described deficiencies of conventional approaches including devices/products and methods thereof, are merely intended to provide an overview of some of the problems of conventional approaches and are not intended to be exhaustive. Other problems with conventional approaches, and methods and their corresponding benefits of the various non-limiting embodiments described herein may become further apparent upon review of the following description.

### OBJECTIVE OF THE INVENTION

Some of the objectives of the present invention, which at least one embodiment herein satisfies, are as follows:

An objective of the present invention is to provide a system for collection of micro-plastics from aquatic environment.

Another objective of the present is to provide a method for collection of micro-plastics from aquatic environment.

Yet another objective of the present invention is to provide an eco-friendly and non-toxic method for collection of micro-plastics from aquatic environment.

Yet another objective of the present invention is to provide a system and method for collecting micro-plastics while the vessel (1) is moving.

Other aspects, advantages, and salient features of the invention will become apparent to those skilled in the art from the following detailed description, which, details the invention in different embodiments.

### SUMMARY OF THE INVENTION

Accordingly, present invention aims to provide a system for collecting micro-plastics in an aquatic environment, the system comprising:
a bow section (2) with an extended pair of arms (3) which form a confined area for waves to enter and collide with the inner walls of the extended arms (3) above the bottom baseline and the bow to naturally generate air bubbles;
at least one air bubble generating unit (4) operationally coupled to the bow section (2);
a mesh net with a plurality of pipes (6) having plurality of holes (7) connected to an adhesive storage unit (8),
a collection unit (9) to collect micro-plastics that flow with the wave through a hole in the vessel's bottom in the stern section (10).

In one of the embodiments the present invention the air bubble generating unit (4) is selected from air blower, air compressor, or similar devices.

In one of the embodiments of the present invention, the adhesive storage unit (8) is equipped with a pump (11) that controls the flow of adhesive material, via a sensor connected to the microprocessor; and In an embodiment of the present invention, the air bubble generating unit (4) comprises of pump (11), nozzle and flow control valve.

In an embodiment of the present invention, the air bubble generating unit (4) provides air bubbles in the confined space between the pair of extended arms (3) in the bow section (2) above the bottom line.

In another embodiment of the present invention, the adhesive material is selected from synthetic or natural adhesives; wherein the synthetic adhesive is synthetic polymer selected from polyvinyl alcohol, and the natural adhesive is selected from adhesive proteins, organic starch, bee-wax, flour paste, tree sap, casein glue or any combination thereof.

In another embodiment of the present invention, the adhesive material is released into the water alongside the air bubbles from the nozzle in the air bubble generating unit (4) and through holes (7) in the pipes (6) in an amount sufficient for micro-plastics to adhere.

In yet another embodiment of the present invention, the adhesive material is solution of synthetic polymer.

In another embodiment of the present invention, the synthetic polymer weight in a range of from 1 to 50 wt % of the solution.

In another embodiment the present invention, further comprising buttock stern hull with wider width coupled with a collection unit (9). The collection unit (9) is coupled to a purifying unit, wherein the micro-plastics are separated from air bubbles, adhesive materials and phytoplankton.

In yet another embodiment of the present invention, the collection unit (9) may be equipped with a roller or brush to turn up the air bubble friction with micro-plastics to flow into the collection unit (9) efficiently.

In an embodiment the present invention further comprises a storage tank (14) connected to a nutrient tank (15) for storing phytoplankton.

In another embodiment of the present invention, the phytoplankton are reintroduced into the water, revitalising the ocean surface zone and increasing photosynthesis.

In another embodiment of the present invention, a method for collecting micro-plastics in an aquatic environment, the method comprising;
allowing the waves to enter the confined area and collide with the inner walls of the extended arms (3) and bow to naturally generate air bubbles;
mixing adhesive material with the air bubbles generated naturally or via pressurized air at the bubble generating unit (4) exit;
adhering the micro-plastics to air bubble using a mesh net (5) with a plurality of pipes (6) with a plurality of holes (7), wherein the mesh collides with each other to enhance the cohesiveness;
collecting micro-plastics that flow with the wave in a collection unit (9) through a hole in the vessel's bottom above the bottom base line in the stern section (10); and
separating micro-plastics from air bubbles, adhesive materials, and phytoplankton in the purifying unit.

In yet another embodiment the present invention further comprises a sensorcoupled to the microprocessor in the collection unit (9), wherein based on the data received microprocessor controls the flow of the adhesive material through the pump (11).

In another embodiment of the present invention, wherein the adhesive material is released into water alongside the air bubbles through holes (7) in the pipes (6) in an amount sufficient for micro-plastics to adhere.

In yet another embodiment of the present invention, the phytoplankton are transferred to storage tank (14), and phytoplankton storage tank (14) shall release the phytoplankton together with fresh phytoplankton in to the ocean surface.

### BRIEF DESCRIPTION OF THE DRAWINGS

FIG. 1 illustrates a schematic diagram of a vessel (1) for collecting micro-plastics.

FIG. 2 illustrates a schematic top view of bow section of the vessel (1)

FIG. 3 illustrates an exploded side view of the bow section of the vessel (1) with a mesh net as adopted in an embodiment of the invention.

FIG. 4 illustrates an exploded side view of the stern section of the vessel (1) mesh net as adopted in an embodiment of the invention.

FIG. 5 illustrates a cross-sectional view of a mesh net (5) in accordance to an embodiment of the invention. Crisscross may include those that do not intersect at right angles.

### LIST OF REFERENCE NUMERALS

1 Vessel
2 Bow Section
3 Extended Pairs of Arms
4 Bubble Generating Unit
4a Confined Area
5 Mesh Net
5a Air in mesh net
5b Adhesive substance in mesh net
6 Plurality of Pipes
7 Plurality of Holes
8 Adhesive Storage Unit
9 Collection Unit
10 Stern Section
11 Pump
12 Phytoplankton Storage tank
13 Nutrient Tank
14 Rudder
15 Propeller
W Sea water level

### Description of the Invention

The exemplary mode for carrying out the disclosure is presented in terms of its exemplary embodiments. However, the exemplary embodiments described herein detail for illustrative purposes and are subject to many variations. It is understood that various omissions and substitutions of equivalents are contemplated as circumstances may suggest or render expedient, but are intended to cover the application or implementation without departing from the spirit or scope of the present disclosure.

The use of terms “including,” “comprising,” or “having” and variations thereof, herein are meant to encompass the items listed thereafter and equivalents thereof as well as additional items.

Further, the terms, “an” and “a” herein do not denote a limitation of quantity, but rather denote the presence of at least one of the referenced item.

Still further, the term “may” herein is used in a permissive sense (i.e. meaning having the potential to), rather than the mandatory sense, (i.e. meaning must).

Furthermore, the term “vessel” herein is used to represent a watercraft used for travel in water. It may be but not limited to a ship or a boat.

Furthermore, the term “aquatic environment” herein is used to represent a water body for example: river, sea, ocean, ponds, lakes etc.

The present invention provides a system for the collection of micro-plastics using synthetic polymers to enhance the adhesion between air bubbles and the micro-plastics, such that the maximum amount of micro-plastics can be collected from aquatic environments. Further, the present invention provides a method for the collection of micro-plastics using synthetic polymers to enhance the adhesion between air bubbles and the micro-plastics, such that the maximum amount of micro-plastics can be collected from aquatic environments.

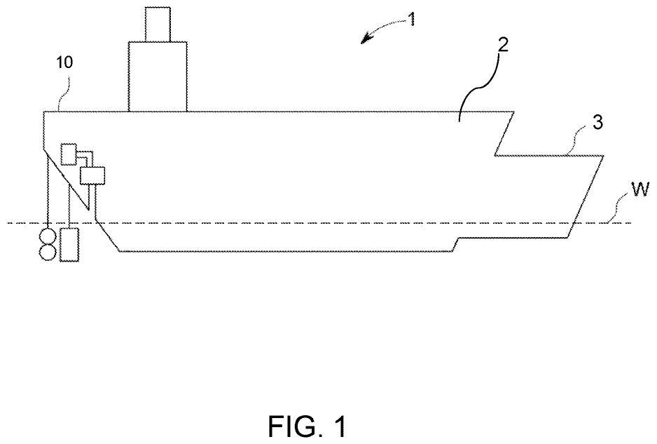

FIG. 1 illustrates a schematic diagram of a vessel (1) for collecting micro-plastics from an aquatic environment as may be adopted in an embodiment of the invention. The vessel (1) may be selected from a cargo ship, a passenger ship, a defense ship, a research ship or a fishing ship or the like. The vessel (1) may comprise a bow section (2) and a stern section (10). The bow section (2) may have an extended pair of arms (3) along with a bow above the bottom baseline. The bow may be disposed on middle of the bow section (2) of the vessel (1). The bow may be selected from a plumb bow, a raked bow, a flared bow, a clipper bow, an inverted bow, a ram bow, high chin spoon bow, a low chin spoon bow, a single indented bulbous bow, a slide shape vertical bow or the like.

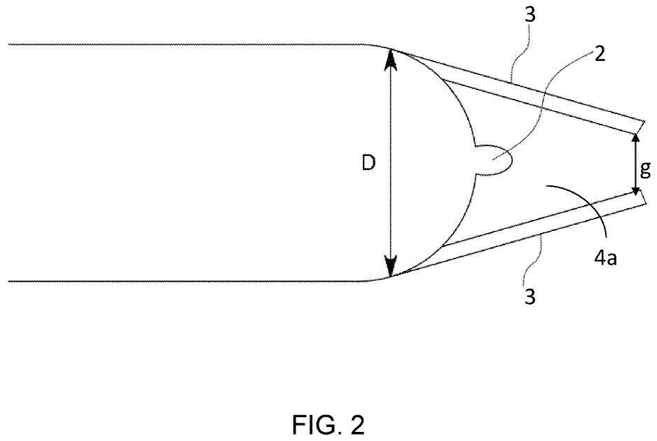

The extended arms (3) may be coupled to a fore part of the vessel (1). The extended arms (3) and the bow may create a confined area (4a), as illustrated in FIG. 2. In the confined area, a wave may enter through a gap between distal ends of the extended arms (3) and may collide with inner walls of the extended arms (3) and the bow, thus air bubbles may be generated naturally. Due to hydrophobic nature of micro-plastics, the micro-plastics may get adhered to the air bubbles.

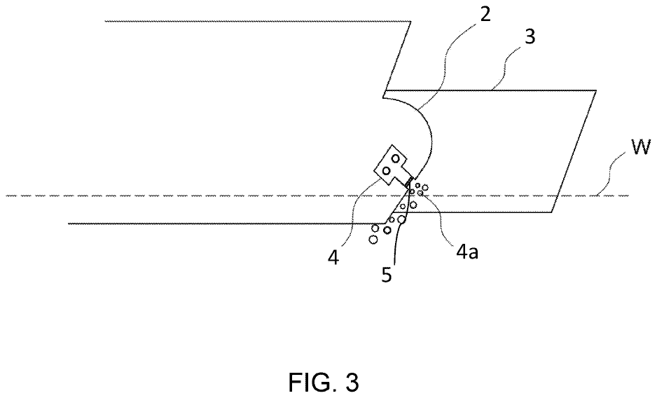

The air bubble generating unit (4) may also be provided on the vessel (1) which may be operationally coupled to the bow of the vessel (1), as illustrated in FIG. 3. The air bubble generating unit (4) may comprise an air blower, an air compressor or any other dedicated system may use to create air bubbles. The air bubble generating unit (4) may be configured to provide additional air bubbles in the confined space between the pair of extended arms (3) above water level.

The air bubble generating unit (4) may also include a pump (11), nozzle and flow control valve. The nozzle is connected to the adhesive storage tanks (8) and releases adhesive material into the sea water along with the air bubble. The flow control valve is linked to a sensor, which measures the amount of micro-plastics collected in the collection unit (9) as well as the vessel speed. The microprocessor send instructions to the pump (11) and actuator based on sensor data to control the flow of adhesive material from the nozzle. If the vessel (1) is travelling at a high speed, the sensor will provide data to the microprocessor. Following that, the microprocessor will command the pump (11) to increase the flow rate of adhesive material, and in case of slow speed, valves will be closed. Thus, the amount of synthetic polymer required and released can be determined by the presence of micro-plastics and vessel's speed.

The amount of adhesive material is released into the sea water is affected by the speed of the vessel (1) like ships. The injection nozzle for releasing adhesive material is located roughly 10-30 cm in front of the ship's bottom. For example, if a ship is sailing at 12.5 knots, it moves at a rate of around 6 meters per second. The air bubbles also mix with the adhesive ingredient on the water's surface.

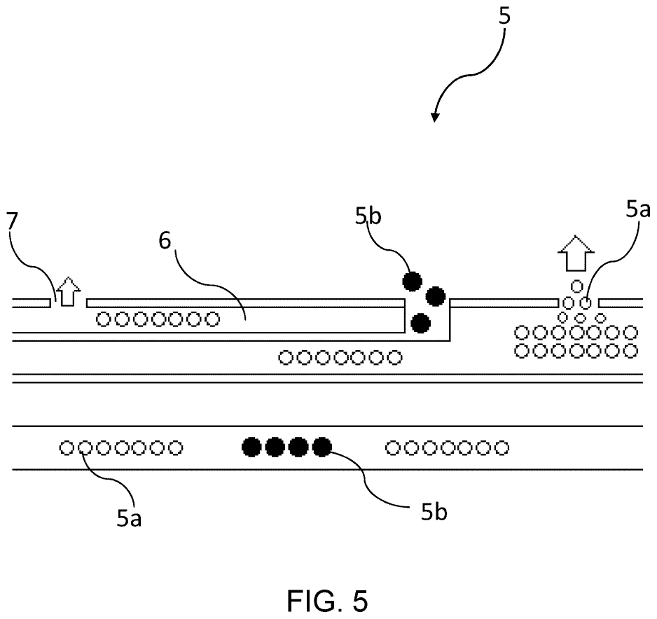

At the exit of the air bubble generating unit (4), a mesh net (5) may be provided. The mesh net may be as shown in FIG. 5. The adhesive storage unit (8) may store synthetic polymers or natural adhesive in a liquid state. The adhesive materials are non-toxic, biodegradable, recyclable and repulpable. The synthetic polymer is non-toxic in nature and may easily be consumed by aquatic animals without causing any harmful effect on them. The synthetic polymers may be selected from polyvinyl alcohol (PVA); and natural adhesive is selected from adhesive proteins, organic starch, bee-wax, flour paste, tree sap, casein glue or any combination thereof.

As seen, the mesh net according to an embodiment of the present invention is made our pipes with holes allowing air to enter therein, as illustrated as 5a. While, the synthetic polymers 5b get mixed with the air and accordingly air bubbles containing the synthetic polymers are released into the aquatic environment.

In an embodiment of the present invention, the adhesive material is solution of polyvinyl alcohol. The polyvinyl alcohol weight in a range of 1-50 wt % of the solution, preferably 1-25 wt %, most preferably 1-10 wt %. Polyvinyl alcohol is biodegradable and soluble in water, has a melting point of 180 to 190° C. Polyvinyl alcohol with degree of hydrolysis less than 90%, preferably 86.5 to 89%, is used in the present invention.

The mesh net (5) may comprise of a plurality of pipes (6) arranged in a crisscross arrangement. The plurality of pipes (6) may be connected to the adhesive storage unit (8). The synthetic polymers (5b) may flow from the adhesive storage unit (8) to the plurality of pipes (6) and get mixed with air (5b) present in the pipes under the gravitational force. At the entry of the plurality of pipes (6), a valve may be provided. Further, an actuator may be coupled to the valve, which opens and closes the valve on instructions of a microprocessor.

In another embodiment, a pump (11) may have been provided. The pump (11) may be configured to move the adhesive material from the adhesive storage unit (8) to the plurality of pipes (6). The pump (11) may also be configured to control the flow of the adhesive material in the plurality of pipes (6).

The plurality of pipes (6) may comprise plurality of holes (7). The plurality of holes (7) may allow the synthetic polymers to flow drop-wise from the plurality of holes (7) into the exit of the air bubble generating unit (4). The mesh (5) is present on the opposite side of the eject. The mesh (5) can collide with each other to enhance the cohesiveness. This also follows the inflow of air bubbles from bow section (2). These three ways of flow enhancement generate the air bubbles together with the cohesiveness of micro-plastic, synthetic polymers, and organic starch.

Further, the air bubble generating unit (4) provides pressurized air at the exit of the air bubble generating unit (4). Thus, the adhesive material may mix with the air and spread over a large area in the confined space. Between the air bubble and the micro-plastics, the adhesive material may generate an electrostatic charge. Therefore, the adhesion force between the air bubbles and the micro-plastics may increase.

The micro-plastics adhere to the air bubbles and the adhesive material may flow with the wave from the bow section (2) to a collection unit (9) through a hole provided on a bottom of the vessel (1) in the stern section (10).

The flat bottom and flow of water current with the movement of the vessel (1), cause air bubbles to mixing and interaction with one another. The interaction, flow of water current and adhesive material causes micro-plastics to adhere to the surface of air bubbles or get trapped inside them. Adhesive material, is biodegradable, so the excess adhesive material degrades slowly, and the micro-plastics are collected at the stern of the ships The micro-plastics adhered to the air bubble may flow upward in the collection unit (9) due to buoyant forces. The collection unit (9) may be configured to collect the micro-plastics adhered to the air bubbles and the adhesive material.

The air bubble rises to the sea surface and comes into contact with adhesive material covered surface of the micro-plastic capture mechanism. Micro-plastic present in seawater adhere to the adhesive-coated surface and are therefore trapped. The micro-plastic capture mechanism collects micro-plastics using mesh net (5) or similar structure. The mesh net (5) comprises of a plurality of pipes (6) arranged in a crisscross pattern with plurality of holes (7). The pipes (6) are connected to the adhesive storage unit (8), and the holes (7) allow the adhesive material to flow drop-wise into the water and air.

In a preferred embodiment, the adhesive material is polyvinyl alcohol (PVA) as it is biodegradable and soluble in water, has a melting point of 180 to 190° C. Polyvinyl alcohol having degree of hydrolysis less than 90%, preferably 86.5 to 89%, is used in the present invention.

The adhesive materials (synthetic or natural adhesive) used is biodegradable and completely dissolves in water over time. Furthermore, the amount of adhesive materials released into water is of little importance because it is non-toxic to aquatic biodiversity.

In an embodiment, a sensor may be coupled to the collection unit. The sensor may be configured to measure the amount of micro-plastics collected in the collection unit (9). The sensor may be coupled to the microprocessor and send data to the microprocessor. Based on the sensor data, the microprocessor may send instructions to the pump (11) and actuator to control the flow of the adhesive material in the plurality of pipes (6). In a case, where there are no micro-plastics present, the sensor will provide data that no micro-plastics is present to the microprocessor. The microprocessor will thereafter instruct the pump (11) to stop and actuator to close the valve, so that the adhesive material can be saved. In a case, where the sensor detects increase in amount of micro-plastics, the microprocessor may instruct the pump (11) and the actuator to increase the flow rated of the adhesive in the plurality of pipes (6). Thus, in this way the quantity of synthetic polymers used may be determined by the presence of micro-plastics.

A purifying unit may be coupled to the collection unit (9). The purifying unit may separate micro-plastics, air bubbles, adhesive material and phytoplankton and collects the separated micro-particles. The purifying unit may comprise a simple filter like an active carbon filter or a fine mesh filter not allowing anything above 5 mm to pass through or a complicated system like Dyson vacuum cleaner which may have a drum or vacuum bin on which the micro-particles adhered with the air bubbles and the adhesive material goes into the top corner of a drum or vacuum bin, and the angle it enters the bin causes it to centrifugal forces spiral around, creating centrifugal force. This force causes the air bubbles to burst and the micro-particles to spin out and fall to the bottom of the bin. The collected micro-plastics may be removed on reaching to destination shore by empty the collected micro-plastics or by an aerial vehicle (such as a drone) taking away the collected micro-plastics, or the like. In another embodiment, the collected micro-plastics may get burn on the vessel (1) by using ultrasonic waves or microwaves.

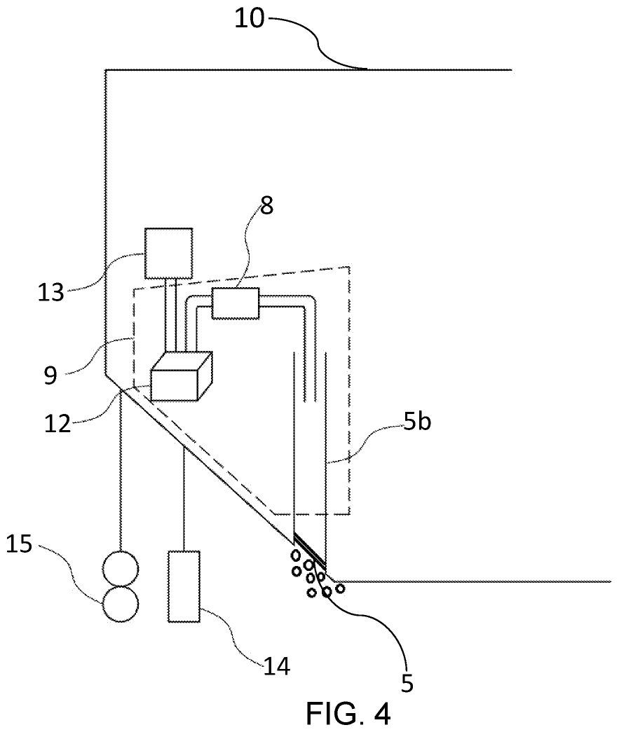

Phytoplankton and other small biodiversity are often trapped and collected along with the micro-plastics. The phytoplankton, small biodiversity, micro-plastics are separated transferred to a storage tank (12) (as illustrated in FIG. 4). The vessel (1) may also comprise a nutrient tank (13) (as illustrated in FIG. 4) to store nutrient which such as nitrates, phosphates, sulfur or chlorella. Nutrient tank (13) is connected to phytoplankton storage tank (14) and regularly provides nutrients to the phytoplankton. Storage tank (12) may comprise a light source in addition to an inlet for sea water. The light source may be an LED bulb, LED plant bulb, LED grow bulb or the like. The inlet for sea water may be capable of allowing an intake of phytoplankton. The phytoplankton are found in abundance, floating in the upper part of the water bodies, where sunlight penetrates the water.

The collected and fresh phytoplankton are released into the water body, thus, revitalizing the ocean surface and enhance the photosynthesis rate. Vessels (1) such as commercial ships, fishery boats and other sailing vessels installed with the system of present invention shall improve the rate of photosynthesis and convert more carbon dioxide to oxygen. Increase in population of phytoplankton will attract more fishes to the ocean surface zone, and will lead to increase in CO₂ fixation and O₂ production.

The present invention system improves air bubble efficiency over blowing micro bubbles from the bottom. The air bubbles move beneath the water to the bottom of the vessel (1), and the blow from the bow helps the bubbles cover the bottom section of the ship and move towards the stern section (10). The pressure difference caused by depth is used by the stern section (10). Air bubbles move from the bottom line to the collection unit (9) due to the pressure difference. Additionally, the pressure at ejecting of air bubbles is larger than the pressure of the sea water including flow of the sea water, enabling the air bubbles to pass through the mesh pipes, and into the sea water. Accordingly, the injected air bubbles can control properly to optimize the air bubbles flow to the outside of the meshIn contrast to fish tail ships, the buttock stern maximizes slop while also providing constant inclination, resulting in a larger width of the collection unit (9). Furthermore, buttock stern hull with wider width coupled with a collection unit (9), and collection unit (9) may be equipped with roller, to turn up the air bubble friction with micro-plastic to flow into the collection unit (9) efficiently.

The present invention further improves the rate of photosynthesis of ocean surface zone and conversion of CO₂ to O₂ by reintroduction of phytoplankton, as a global warming mitigation method.

### Example 1

Working of the present invention: Waves enter the confined area and collide with the inner walls of the extended arms (3) and the bow, forming air bubbles. Polyvinyl alcohol, the adhesive agent, is released from the nozzle and pipe holes onto the sea water surface and between the ship's bottom and the sea surface. The air bubbles (from the air bubble generator, bow section (2)) and micro-plastics come into contact with the polyvinyl alcohol layers. Under the action of the polyvinyl alcohol, the micro-plastic adheres to the surface of the air bubbles, agglomerates, and flows into the collection unit (9) in the stern portion. In a purifying unit connected to the collection unit (9), collected micro-plastics are separated from air bubbles, polyvinyl alcohol, and phytoplankton. The polyvinyl alcohol collected from separation is transferred to adhesive storage tanks (8).

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiment was chosen and described in order to best explain the principles of the disclosure and its practical application, to thereby enable others skilled in the art to best utilize the disclosure and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present disclosure.

1. A system for collecting micro-plastics in an aquatic environment, the system comprising:
a bow section (2) with an extended pair of arms (3) which form a confined area for waves to enter and collide with the inner walls of the extended arms (3) above the bottom baseline and the bow to naturally generate air bubbles;
at least one air bubble generating unit (4) operationally coupled to the bow section (2);
a mesh net (5) with a plurality of pipes (6) having plurality of holes (7) connected to an adhesive storage unit (8); and
a collection unit (9) to collect micro-plastics that flow with the wave through a hole in the vessel's bottom in the stern section (10).

2. The system as claimed in claim 1, wherein the air bubble generating unit (4) is selected from air blower, air compressor, or similar devices.

3. The system as claimed in claim 1, wherein the air bubble generating unit (4) comprises a pump (11), nozzle and flow control valve.

4. The system as claimed in claim 1, wherein the air bubble generating unit (4) provides air bubbles in the confined space between the pair of extended arms (3) in the bow section (2) above the bottom line.

5. The system as claimed in claim 1, wherein the adhesive storage unit (8) is equipped with a pump (11) that controls the flow of adhesive material, via a sensor connected to a microprocessor.

6. The system as claimed in claim 1, wherein the adhesive material is selected from synthetic or natural adhesives; wherein the synthetic adhesive is synthetic polymers selected from polyvinyl alcohol, and the adhesive is selected from adhesive proteins, organic starch, bee-wax, flour paste, tree sap, casein glue or any combination thereof.

7. The system as claimed in claim 1, wherein the adhesive material is released into water alongside the air bubbles from nozzle in the air bubble generating unit (4) and through holes (7) in the pipes (6) in an amount sufficient for micro-plastics to adhere.

8. The system as claimed in claim 1, wherein the adhesive material is a solution of synthetic polymer.

9. The system as claimed in claim 1, wherein the synthetic polymer weight in a range of from 1 to 50 wt % of the solution.

10. The system as claimed in claim 1, further comprises a buttock stern hull with a wider width coupled with a collection unit (9).

11. The system as claimed in claim 1, wherein the collection unit (9) is coupled to a purifying unit, wherein the micro-plastics are separated from air bubbles, adhesive materials, and phytoplankton.

12. The system as claimed in claim 11, wherein the collection unit (9) may be equipped with a roller or brush to turn up the air bubble friction with micro-plastic to flow into the collection unit (9) efficiently.

13. The system as claimed in claim 11, further comprises a storage tank (14) connected to a nutrient tank (15) for storing phytoplankton.

14. The system as claimed in claim 13, wherein phytoplankton are reintroduced into the water, revitalising the ocean surface zone and increasing photosynthesis.

15. A method for collecting micro-plastics in an aquatic environment, the method comprising:
allowing the waves to enter the confined area and collide with the inner walls of the extended arms (3) and bow to naturally generate air bubbles;
mixing adhesive material with the air bubbles generated naturally or via pressurized air at the bubble generating unit (4) exit;
adhering the micro-plastics to air bubble using a mesh net (5) with a plurality of pipes (6) with a plurality of holes (7), wherein the mesh (5) collides with each other to enhance the cohesiveness;
collecting micro-plastics that flow with the wave in a collection unit (9) through a hole in the vessel's bottom above the bottom base line in the stern section (10); and
separating micro-plastics from air bubbles, adhesive materials, and phytoplankton in purifying unit.

16. The method as claimed in claim 15, further comprises a sensor coupled to the microprocessor in the collection unit (9), wherein based on the data received, the microprocessor controls the flow of the adhesive material through the pump (11).

17. The method as claimed in claim 15, wherein the adhesive material is released into the water alongside the air bubbles through holes (7) in the pipes (6) in an amount sufficient for micro-plastics to adhere.

18. The method as claimed in claim 15, wherein the phytoplankton are transferred to a storage tank (14).

19. The method as claimed in claim 15, wherein the phytoplankton storage tank (14) releases phytoplankton together with fresh phytoplankton into the ocean surface.
